(19) United States
(12) Patent Application Publication
(10) Pub. No.: US 2009/0007779 A1
(43) Pub. Date: Jan. 8, 2009

(54) METHOD AND SYSTEM OF PROVIDING CARBON DIOXIDE-ENRICHED GAS FOR GREENHOUSES

(76) Inventors: Philippe A. COIGNET, Bear, DE (US); Rajeev S. PRABHAKAR, Wilmington, DE (US)

Correspondence Address: AIR LIQUIDE;Intellectual Property, 2700 POST OAK BOULEVARD, SUITE 1800, HOUSTON, TX, 77056, US

(21) Appl. No.: 11/966,786

(22) Filed: Dec. 28, 2007

Related U.S. Application Data
(60) Provisional application No. 60/938,519, filed on May 17, 2007.

(51) Int. Cl. B01D 53/00; B01D 53/047; B01D 53/22; A01G 9/18

(52) U.S. Cl. 95/51; 95/139; 47/17; 55/385.4

(57) ABSTRACT

A feed gas is separated into a CO₂-lean stream and a CO₂-enriched stream at a CO₂ enriching unit. The CO₂-enriched gas is fed to a greenhouse to enhance plant growth. The feed gas may include air and/or vent gas from the greenhouse.

### CROSS-REFERENCE TO RELATED APPLICATIONS

This patent application claims priority to U.S. Provisional Patent Application 60/938,519 filed May 17, 2007.

### BACKGROUND

Ambient CO₂ concentration within a greenhouse can decrease below normal atmospheric levels due to CO₂ uptake by plants. Lower CO₂ concentration results in slower rates of photosynthesis and hence slower plant growth. Therefore, CO₂ is often added to greenhouses to maintain a CO₂ concentration within the greenhouse at atmospheric levels (about 380-400 ppm).

Many plants exhibit higher rates of photosynthesis when they are grown in atmospheres with elevated CO₂ concentrations (up to 2000 ppm) than if they are grown in air. Higher photosynthesis rates result in increased plant growth. Thus, plant growers often supply air containing 550-2000 ppm CO₂ during daytime hours to enhance the growth of plants such as tomatoes, peppers, flowers, etc.

One conventional technique for providing a CO₂-enriched atmosphere is to feed a mixture of air and an exhaust gas (produced from an on-site fuel burner) into an interior of the greenhouse. However, this technique sometimes presents a mismatch between heat and CO₂ requirements from the greenhouse. This technique is disadvantageous because the exhaust from the fuel burners may include undesirable gas species like sulfur compounds and CO.

Another conventional technique for providing such a CO₂-enriched atmosphere includes feeding vaporized liquid CO₂ into an interior of the greenhouse or combining the vaporized liquid CO₂ with air and feeding the resultant mixture into the interior. However, this technique presents two significant disadvantages. First, the use of liquid CO₂ requires safety controls because it can potentially result in unsafe CO₂ levels in air. Second, the supply and storage of liquid CO₂ adds additional complexity to the process because of supply-chain issues and potential refrigeration requirements.

Regardless of whether liquid CO₂ or fuel burners are used, a significant portion of the CO₂ injected into the greenhouse is often lost due to presence of leaks and ventilation.

Thus, it is an object of the invention to overcome the above problems by providing an improved method and system for growing plants in a CO₂-enriched atmosphere.

### SUMMARY

A method of providing a CO₂-enriched gas to a greenhouse includes the following steps. A feed gas is fed to a CO₂ enriching unit. The feed gas is separated into a CO₂-lean stream and a CO₂-enriched stream. The CO₂-enriched stream is fed to a greenhouse containing plants.

The method may optionally include one or more of the following aspects:
the feed gas is air.
the feed gas comprises a vent gas collected from an outlet of the green house.
injecting CO₂ into the greenhouse from a backup CO₂ source.
injecting CO₂ into the greenhouse from a backup CO₂ source wherein the CO₂ is obtained by vaporizing a portion of liquid CO₂ from a vessel containing liquid CO₂.
injecting CO₂ into the greenhouse from a backup CO₂ source wherein the backup CO₂ source is a flue gas-generating fuel burner.
the CO₂ enriching unit is an adsorbent-based unit selected from the group consisting of a pressure swing adsorption unit, a vacuum swing adsorption unit, a thermal swing adsorption unit, an electrical swing adsorption unit, and combinations thereof.
the CO₂ enriching unit is an adsorbent-based unit selected from the group consisting of a pressure swing adsorption unit, a vacuum swing adsorption unit, a thermal swing adsorption unit, an electrical swing adsorption unit, and combinations thereof wherein an adsorbent in the adsorbent-based unit is selected from the group consisting of a molecular sieve, activated alumina, activated carbon, silica gel, metal oxides, a mixture of NaOH and CaO, carbonic anhydrase enzyme, an enzyme derived from carbonic anhydrase, and solid amines.
the CO₂ enriching unit is a membrane.
an interior of the greenhouse has a CO₂ concentration in a range from about 550 ppm to about 2000 ppm.
an interior of the greenhouse has a CO₂ concentration in a range from a concentration of CO₂ found in air surrounding the greenhouse to about 2000 ppm.
target CO₂ concentration to be achieved in the greenhouse, wherein a CO₂ concentration of the gas feed stream is less than the target CO₂ concentration.

A system for growing plants in a CO₂-enriched atmosphere includes a greenhouse containing plants and a CO₂ enriching unit in fluid communication with the greenhouse that is adapted and configured to separate a feed gas stream into a CO₂-enriched stream and a CO₂-lean stream.

The system may include one or more of the following aspects:
a vent of the greenhouse is in fluid communication with an inlet of the CO₂ enriching unit.
the system further includes a source of CO₂ in fluid communication with the greenhouse.
the system further includes a source of CO₂ in fluid communication with the greenhouse wherein the CO₂ source is liquid CO₂, the backup source of CO₂ being adapted and configured to allow a portion of the liquid CO₂ to be vaporized and injected into the greenhouse.
the system further includes a backup source of CO₂ in fluid communication with the greenhouse wherein the backup CO₂ source is a flue gas-generating fuel burner.
the CO₂ enriching unit is an adsorbent-based unit selected from the group consisting of a pressure swing adsorption unit, a vacuum swing adsorption unit, a thermal swing adsorption unit, an electrical swing adsorption unit, and combinations thereof.
the CO₂ enriching unit is an adsorbent-based unit selected from the group consisting of a pressure swing adsorption unit, a vacuum swing adsorption unit, a thermal swing adsorption unit, an electrical swing adsorption unit, and combinations thereof wherein an adsorbent in the adsorbent-based unit is selected from the group consisting of a molecular sieve, activated alumina, activated carbon, silica gel, metal oxides, a mixture of NaOH and CaO, carbonic anhydrase enzyme, an enzyme derived from carbonic anhydrase, and solid amines
the CO₂ enriching unit is a membrane.

### BRIEF DESCRIPTION OF THE DRAWINGS

FIG. 1 is a schematic of an embodiment of the invention wherein the feed gas is air.

FIG. 2 is a schematic of another embodiment of the invention wherein the feed gas is vent gas from an outlet of the greenhouse.

### DESCRIPTION OF PREFERRED EMBODIMENTS

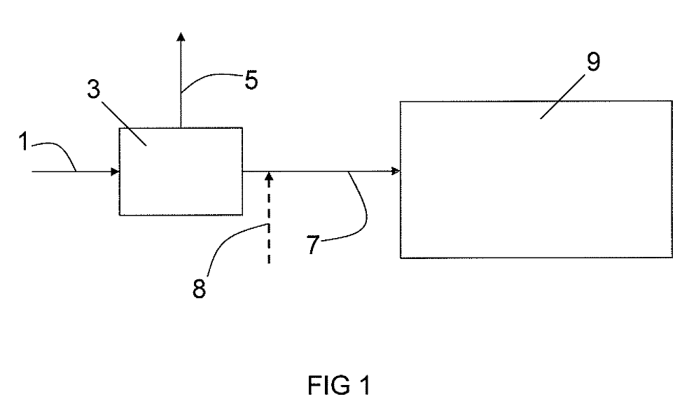

As best shown in FIG. 1, one embodiment of the invention includes feeding a feed gas of air 1 to a CO₂ enriching unit 3 where it is separated into a CO₂-lean stream 5 and a CO₂-rich stream 7. The CO₂-lean stream 5 is vented while the CO₂-rich stream 7 is fed to greenhouse 9. The phrase “fed to greenhouse 9” means that it is directly fed or that it may be optionally diluted with air. Thus, if the CO₂ concentration of the CO₂-rich stream 7 exiting the CO₂-enriching unit 3 is higher than desired, a stream of air 8 may be used to lower the CO₂ concentration to the desired level. In this embodiment, the feed gas 1 is air typically with a CO₂ concentration of about 400 ppm depending upon local conditions such as the relative degree of industrialization.

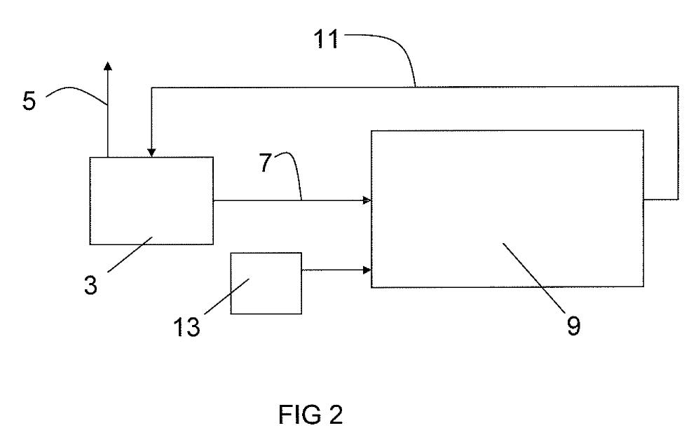

As best depicted in FIG. 2, the feed gas comprising greenhouse vent gas 11 is fed to the CO₂-enriching unit 3 instead of air. In this embodiment, CO₂ from a backup CO₂ source 13 may optionally be used to boost the amount of CO₂ in the greenhouse 9 if the CO₂-enriched stream 7 does not have a concentration and/or mass flow rate high enough to achieve a desired target CO₂ concentration within the greenhouse 9. The backup CO₂ source 13 may be gaseous CO₂ obtained by vaporizing a portion of liquid CO₂ from a vessel containing liquid CO₂. Alternatively, the backup CO₂ source 13 may be a conventional flue gas-generating burner. While FIG. 2 depicts supply 13 as located outside the greenhouse 9, one of ordinary skill in the art will recognize that it may just as easily be located inside the greenhouse 9.

Any one or more of several adsorbent-based technologies may be used for the CO₂-enriching unit 3, including but not limited to, a pressure swing adsorption (PSA) unit, a vacuum swing adsorption (VSA) unit, a thermal swing adsorption (TSA) unit, an electrical swing adsorption (ESA) unit. Alternatively, a combination of two or more of the foregoing may be used in a single CO₂-enriching unit 3. Suitable adsorbents include a molecular sieve, activated alumina, activated carbon, silica gel, metal oxides, Na₂CO₃, a mixture of NaOH and CaO, a solid enzyme such as carbonic anhydrase (or an analogue thereof), and solid amines. A most preferred adsorbent is activated carbon.

The above adsorbent-based technologies and adsorbents are well known in the art and detailed descriptions of them are not needed herein. However, in practice of the invention, instead of using the CO₂-lean stream and rejecting the CO₂-enriched stream from the CO₂-laden adsorbent, the CO₂-enriched stream 7 is injected into the greenhouse, while the CO₂-lean stream 5 is rejected. Despite being contrary to conventional practice, one of ordinary skill will readily understand how to operate such adsorbent-based systems in this manner.

Alternatively, a gas separation membrane maybe used in the CO₂-enriching unit 3. In such case, suitable membranes include polymeric hollow fiber membranes such as those described in U.S. Pat. No. 5,468,430, U.S. Pat. No. 5,618,332, and U.S. Pat. No. 5,820,659, the contents of which are incorporated herein in their entirety and which are available commercially from Medal, a wholly owned subsidiary of Air Liquide Advanced Technologies U.S., located in Newport, Del. Of course, conventional operation of these membranes involves rejection of the CO₂-enriched permeate. In practice of the invention, however, the CO₂-enriched stream 7 is instead injected into the greenhouse and the CO₂-lean stream 5 is vented.

Preferably, the CO₂-enriching unit 3 is operated in such a manner to provide a CO₂ concentration in the greenhouse 9 in the range from the concentration of CO₂ found in air surrounding the greenhouse 9 to about 2000 ppm. Preferably, it is operated in such a manner to provide a CO₂ concentration in a range of from about 550 ppm to about 2000 ppm. However, it is within the invention to produce lower or even higher CO₂ concentrations in the greenhouse 9 if desired. One of ordinary skill in the art will recognize that the optimal ranges of CO₂ concentrations to be provided within the greenhouse 9 may depend upon the specie or species of plants growing inside.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A method of providing a CO₂-enriched gas to a greenhouse, comprising the steps of:
feeding a feed gas to a CO₂ enriching unit;
separating the feed gas into a CO₂-lean stream and a CO₂-enriched stream; and
feeding the CO₂-enriched stream to a greenhouse containing plants.

2. The method of claim 1, wherein the feed gas is air.

3. The method of claim 1, wherein the feed gas comprises a vent gas collected from an outlet of the greenhouse.

4. The method of claim 1, further comprising the step of injecting CO₂ into the greenhouse from a backup CO₂ source.

5. The method of claim 4, further comprising the step of vaporizing a portion of liquid CO₂ from a vessel containing liquid CO₂.

6. The method of claim 4, wherein the backup CO₂ source is a flue gas-generating fuel burner.

7. The method of claim 1, wherein the CO₂ enriching unit is an adsorbent-based unit selected from the group consisting of a pressure swing adsorption unit, a vacuum swing adsorption unit, a thermal swing adsorption unit, an electrical swing adsorption unit, and combinations thereof.

8. The method of claim 7, wherein an adsorbent in the adsorbent-based unit is selected from the group consisting of a molecular sieve, activated alumina, activated carbon, silica gel, metal oxides, a mixture of NaOH and CaO, carbonic anhydrase enzyme, an enzyme derived from carbonic anhydrase, and solid amines.

9. The method of claim 1, wherein the CO₂ enriching unit is a membrane.

10. The method of claim 1, wherein an interior of the greenhouse has a target CO₂ concentration in a range of from about 550 ppm to about 2000 ppm.

11. The method of claim 1, wherein an interior of the greenhouse has a target CO₂ concentration in a range of from a concentration of CO₂ found in air surrounding the greenhouse to about 2000 ppm.

12. The method of claim 1, further comprising the step of selecting a target CO₂ concentration to be achieved in the greenhouse, wherein a CO₂ concentration of the gas feed stream is less than the target CO₂ concentration.

13. The method of claim 1, wherein the feed gas is air and the CO₂ enriching unit is an adsorbent-based unit using activated carbon as an adsorbent.

14. The method of claim 1, wherein the feed gas is air and the CO₂ enriching unit is a membrane.

15. A system for growing plants in a CO₂-enriched atmosphere, comprising:
a greenhouse containing plants; and
a CO₂ enriching unit in fluid communication with the greenhouse adapted and configured to separate a feed gas stream into a CO₂-enriched stream and a CO₂-lean stream.

16. The system of claim 15, wherein a vent of the greenhouse is in fluid communication with an inlet of the CO₂ enriching unit.

17. The system of claim 16, further comprising a backup source of CO₂ in fluid communication with the greenhouse.

18. The method of claim 17, wherein the backup CO₂ source is liquid CO₂, said source of CO₂ being adapted and configured to allow a portion of the liquid CO₂ to be vaporized and injected into the greenhouse.

19. The method of claim 17, wherein the backup CO₂ source is a flue gas-generating fuel burner.

20. The system of claim 15, wherein the CO₂ enriching unit is an adsorbent-based unit selected from the group consisting of a pressure swing adsorption unit, a vacuum swing adsorption unit, a thermal swing adsorption unit, an electrical swing adsorption unit, and combinations thereof.

21. The system of claim 20, wherein an adsorbent in the adsorbent-based unit is selected from the group consisting of a molecular sieve, activated alumina, activated carbon, silica gel, metal oxides, a mixture of NaOH and CaO, carbonic anhydrase enzyme, an enzyme derived from carbonic anhydrase, and solid amines

22. The system of claim 15, wherein the CO₂ enriching unit is a membrane.

23. The system of claim 15, wherein the feed gas is air and the CO₂ enriching unit is an adsorbent-based unit using activated carbon as an adsorbent.

24. The system of claim 15, wherein the feed gas is air and the CO₂ enriching unit is a membrane.
